(19) United States
(12) Patent Application Publication
(10) Pub. No.: US 2013/0188698 A1
(43) Pub. Date: Jul. 25, 2013

(54) COEFFICIENT LEVEL CODING

(71) Applicant: QUALCOMM Incorporated, San Diego, CA (US)

(72) Inventors: Wei-Jung Chien, San Diego, CA (US); Jianle Chen, San Diego, CA (US); Joel Sole Rojals, La Jolla, CA (US); Liwei Guo, San Diego, CA (US); Marta Karczewicz, San Diego, CA (US)

(73) Assignee: QUALCOMM INCORPORATED, San Diego, CA (US)

(21) Appl. No.: 13/743,846

(22) Filed: Jan. 17, 2013

Related U.S. Application Data
(60) Provisional application No. 61/588,586, filed on Jan. 19, 2012.
(60) Provisional application No. 61/670,505, filed on Jul. 11, 2012.

(51) Int. Cl. H04N 7/26

(52) U.S. Cl. CPC H04N 19/00781
USPC 375/240.12; 375/240.01

(57) ABSTRACT

In one example, a device includes a video coder configured to code a first set of syntax elements for the coefficients of a residual block of video data, and code, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients. For example, the first set of syntax elements may comprise values indicating whether the coefficients are significant (that is, have non-zero level values), and the second set of syntax elements may comprise values indicating whether level values for the coefficients have absolute values greater than one.

This application claims the benefit of U.S. Provisional Application Ser. No. 61/588,586, filed Jan. 19, 2012, and U.S. Provisional Application Ser. No. 61/670,505, filed Jul. 11, 2012, each of which is hereby incorporated by reference in its respective entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for coding coefficient level values during a video coding process. Video coding generally includes steps of predicting a value for a block of pixels, and coding residual data representing differences between a predicted block and actual values for pixels of the block. The residual data may be transformed to produce transform coefficients. The transform coefficients then may be quantized and entropy coded. Entropy coding may include scanning the quantized transform coefficients to code values representative of whether the coefficients are significant, as well as coding values representative of the values of the quantized transform coefficients themselves, referred to herein as the “levels” of the quantized transform coefficients. In addition, entropy coding may include coding signs of the levels.

In accordance with the techniques of this disclosure, coding of a value representative of whether the absolute value of the level of a coefficient is greater than one may depend on values indicative of whether neighboring coefficients and/or previously parsed coefficients are significant, i.e., have absolute level values greater than zero. Moreover, coding of a value representative of whether the absolute value of the level of a coefficient is greater than two may also depend on values indicative of whether neighboring coefficients and/or previously parsed coefficients are significant, and in addition or in the alternative, may depend on the values representative of whether the absolute values of the levels of previously coded coefficients are greater than one. In this manner, the techniques of this disclosure may achieve higher throughput during coefficient level coding.

In one example, a method includes coding a first set of syntax elements for coefficients corresponding to a residual block of video data, and coding, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

In another example, a device includes a video coder configured to code a first set of syntax elements for coefficients corresponding to a residual block of video data, and code, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

In another example, a device includes means for coding a first set of syntax elements for coefficients corresponding to a residual block of video data, and means for coding, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

In another example, a computer-readable storage medium has stored thereon instructions that, when executed, cause a processor to code a first set of syntax elements for coefficients corresponding to a residual block of video data, and code, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for coefficient level coding.

FIG. 2 is a block diagram illustrating an example of a video encoder that may implement techniques for coefficient level coding.

FIG. 3 is a block diagram illustrating an example of a video decoder that may implement techniques for coefficient level coding.

FIG. 4 is a conceptual diagram illustrating various syntax elements for a block of transform coefficients.

FIG. 5 is a flowchart illustrating an example method for encoding a current block.

FIG. 6 is a flowchart illustrating an example method for decoding a current block of video data.

### DETAILED DESCRIPTION

In general, this disclosure describes techniques for coding coefficient level values during a video coding process. More particularly, this disclosure describes techniques for coding one or more syntax elements for coefficients, where the syntax elements may represent data for the coefficients, such as level values for the coefficients. Video coding generally includes steps of predicting a value for a block of pixels, and coding residual data representing differences between a predicted block and actual values for pixels of the block. During encoding, the residual data, may be transformed and quantized, then entropy encoded. Alternatively, during decoding, entropy encoded data corresponding to the residual data may be entropy decoded, inverse quantized, and inverse transformed to reproduce the residual data. Entropy coding includes coding values representative of the transform coefficients themselves, referred to herein as the “levels” or “level values” of the transform coefficients. In addition, entropy coding may include coding signs (plus or minus) of the levels.

Entropy coding may include grouping quantized transform coefficients of a block into one or more “chunks,” also referred to as “coefficient groups.” The coefficients inside a chunk are typically located spatially close to each other, and the number of the coefficients in a chunk may be predetermined. For example, there may be sixteen coefficients in each chunk. Currently, in high efficiency video coding (HEVC), a chunk is a set of 16 coefficients in scan order. For blocks other than 8×8 pixel blocks, this definition means that a chunk is a 4×4 sub-block.

In the upcoming High Efficiency Video Coding (HEVC) standard, transform coefficients are coded using five syntax elements: whether a coefficient is significant (that is, has a non-zero value, referred to as a significant_coeff_flag), the sign of a non-zero valued coefficient (coeff_sign_flag), whether a significant coefficient has an absolute value greater than one (coeff_abs_level_greater1_flag), whether a coefficient with an absolute value greater than one has an absolute value greater than two (coeff_abs_level_greater2_flag), and a remaining level value of a coefficient having an absolute value greater than two (coeff_abs_level_minus3). The remaining level value generally corresponds to the portion of the actual value of the coefficient that is in excess of two.

During entropy coding, a video coding device may code five syntax elements for each of the coefficients: significant_coeff_flag, coeff_abs_level_greater1_flag, coeff_abs_level_greater2_flag, coeff_sign_flag, and coeff_abs_level_minus3_, as described above. These syntax elements are defined as follows, where (xC, yC) corresponds to the spatial position of a coefficient within a block:

The syntax element “significant_coeff_flag[xC][yC]” specifies, for the transform coefficient position (xC, yC) within the current transform block, whether the corresponding transform coefficient level at location (xC, yC) is non-zero as follows. If significant_coeff_flag[xC][yC] is equal to 0, the transform coefficient level at location (xC, yC) is set equal to 0; otherwise (that is, when significant_coeff_flag[xC][yC] is equal to 1), the transform coefficient level at location (xC, yC) has a non-zero value.

The significant_coeff_flag[last_significant_coeff_x][last_significant_coeff_y] at the last significant location (last_significant_coeff_x, last_significant_coeff_y) in scan order may be inferred to be equal to 1. When significant_coeff_flag [last_significant_coeff_x][last_significant_coeff_y] is inferred to be equal to 1, a value need not necessarily be explicitly coded for significant_coeff_flag [last_significant_coeff_x][last_significant_coeff_y]. Otherwise, when significant_coeff_flag[xC][yC] is not present, it may be inferred to be equal to 0.

The syntax element “coeff_abs_level_greater1_flag[n]” specifies, for the scanning position n, whether there are transform coefficient levels greater than 1. When coeff_abs_level_greater1_flag[n] is not present, it may be inferred to be equal to 0.

The syntax element “coeff_abs_level_greater2_flag[n]” specifies for the scanning position n whether there is a transform coefficient level greater than 2. When coeff_abs_level_greater2_flag[n] is not present, it may be inferred to be equal to 0.

The syntax element “coeff_abs_level_minus3[n]” is the absolute value of a transform coefficient level minus 3 at the scanning position n. The value of coeff_abs_level_minus3 may be constrained by the limits expressed in HEVC. When coeff_abs_level_minus3[n] is not present, it may be inferred as follows: If coeff_abs_level_greater1_flag[n] is equal to 0, coeff_abs_level_minus3[n] may be inferred to be equal to −2. Otherwise (that is, when coeff_abs_level_greater1_flag[n] is equal to 1 and coeff_abs_level_minus3[n] is not present), coeff_abs_level_minus3[n] may be inferred to be equal to −1.

The syntax element “coeff_sign_flag[n]” specifies the sign of a transform coefficient level for the scanning position n as follows. Setting coeff_sign_flag[n] equal to 0 is intended to indicate that the corresponding transform coefficient level has a positive value. Otherwise (that is, setting coeff_sign_flag[n] is equal to 1) is intended to indicate that the corresponding transform coefficient level has a negative value. When coeff_sign_flag[n] is not present, it may be inferred to be equal to 0.

When signaling transform coefficients of a block, all the syntax elements may be signaled chunk by chunk. Within a chunk, all symbols of a single syntax element may be coded first, and then followed by another syntax element. The coding order may be significant_coeff_flag, coeff_abs_level_greater1_flag, coeff_abs_level_greater2_flag, coeff_sign_flag and coeff_abs_level_minus3. In some examples, such as in conventional HEVC, all of the syntax elements are entropy coded with context modeling, except that coeff_abs_level_minus3 and coeff_sign_flag may be bypass coded (that is, coded without context modeling). In general, a context model indicates the probability of a particular bit being entropy coded having a value of zero or one.

Based on the current structure, all significant_coeff_flag of the current chunk and all transform coefficients in the previous chunks are known (that is, parsed and/or coded) before signaling (or coding) coeff_abs_level_greater1_flag. Moreover, all coeff_abs_level_greater1_flag in the chunk are known before signaling (or coding) coeff_abs_level_greater2_flag.

In context modeling of conventional HEVC, there are six context sets for both coeff_abs_level_greater1_flag and coeff_abs_level_greater2_flag of luma coefficients and two context sets for for both coeff_abs_level_greater1_flag and coeff_abs_level_greater2_flag of chroma coefficients. Each context set consists of 4 contexts for coeff_abs_level_greater1_flag and 3 contexts for coeff_abs_level_greater2_flag. The index of the context set, ctxSet, is selected based on the coeff_abs_level_greater1_flag information in a previously coded chunk.

For coeff_abs_level_greater1_flag, the index of the context within a context set, greater1Ctx (reset to default value, 1, for each chunk), is equal to the number of trailing ones (the number of coeff_abs_level_greater1_flag being 0) and capped at 3. After processing the first coeff_abs_level_greater1_flag being 1, the greater1Ctx is set to 0 until the end of the chunk.

The context index can be represented as:

ctxIdx_level_greater1=(ctxSet*4)+Min(3,greater1Ctx) (1)

For coeff_abs_level_greater2_flag, the index of the context within a context set, greater2Ctx (default value is 0), is based on the number of coeff_abs_level_greater1_flag being 1 to a maximum of 2. The context index can be represented as:

ctxIdx_level_greater2=(ctxSet*3)+Min(2,greater2Ctx) (2)

In formula (1) above, greater1Ctx is based on the number of the significant coefficients and the number of the coefficients that are greater than 1. On the other hand, in formula (2) above, greater2Ctx is based on the number of the coefficients that are greater than 2.

In accordance with certain techniques of this disclosure, coding of values representative of whether the absolute value of the level of a coefficient is greater than one and (such as, for example, coeff_abs_level_greater1_flag and/or coeff_abs_level_greater2_flag) may depend on values indicative of whether neighboring coefficients and/or previously parsed/coded coefficients are significant. Moreover, coding of a value representative of whether the absolute value of the level of a coefficient is greater than two may also depend on values indicative of whether neighboring coefficients and/or previously parsed coefficients are significant, and in addition or in the alternative, may depend on the values representative of whether the absolute values of the levels of previously coded coefficients are greater than one. More particularly, coding of a value representative of the level of a current transform coefficient may “depend” on a previously coded value in the sense that context for coding the value may be determined using the previously coded value.

Thus, certain techniques of this disclosure may generally be summarized as coding a first set of syntax elements for coefficients corresponding to a residual block of video data, and coding, using context data determined according to at least a portion of the first set of syntax elements, a second set of syntax elements for the coefficients, wherein the first set of syntax elements each correspond to a first type of syntax element for the coefficients, and wherein the second set of syntax elements each correspond to a second, different type of syntax element for the coefficients.

As discussed above, the first type of syntax element may comprise a type of syntax element representing whether a coefficient has a non-zero value, i.e., is significant (such as a significant coefficient flag). As such, the second type of syntax element may comprise a type of syntax element representing whether a level value for the coefficient has an absolute value that is greater than one (or two). Additionally or alternatively, the first type of syntax element may comprise a type of syntax element representing whether a level value for the syntax element has an absolute value greater than one, while the second type of syntax element may comprise a type of syntax element representing whether the level value has an absolute value greater than two.

Determining contexts for coding values in this manner may allow increased parallelism in coding of transform coefficients. That is, each of the current values of a particular type can be coded in parallel, due to not depending on each other for determination of context. Instead, context for the current values can be determined from previously coded values. For example, as discussed above, when the current values are syntax elements representing whether transform coefficients have absolute values greater than one, the values used to determine context may comprise values indicating whether the transform coefficients are non-zero. Thus, the values indicating whether the transform coefficients are greater than one can be coded in parallel as they rely on values of coefficients that have already been coded. In this manner, the techniques of this disclosure may achieve higher throughput during coefficient level coding.

As an alternative, a video coder may determine context for coding a current syntax element of a particular type using syntax elements of the same type. However, the video coder may be configured to use only syntax elements of the same type that precede the current syntax element by a certain number of coefficients. This number may be equal to the degree of parallelism that can be achieved. For example, if there are four parallel processes, and the current syntax element is the N^{th} syntax element, the video coder may use only one or more of syntax elements at positions less than or equal to (N−4) to determine context for coding the current syntax element at position N. In this manner, coefficients at positions N, N−1, N−2, and N−3 can be coded substantially in parallel.

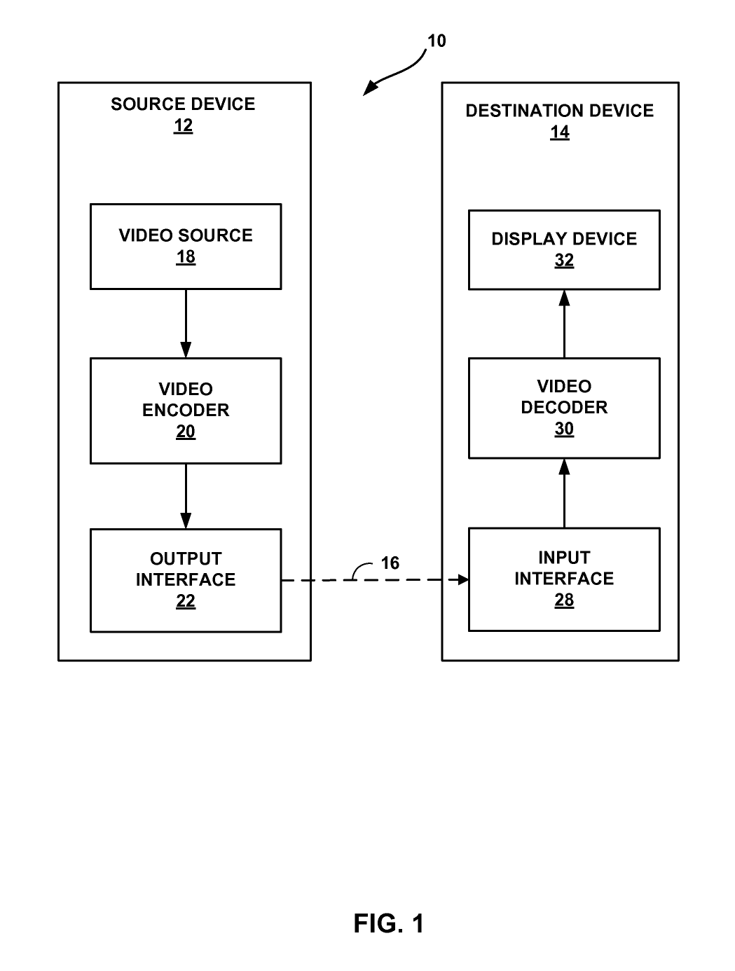

FIG. 1 is a block diagram illustrating an example video encoding and decoding system 10 that may utilize techniques for coefficient level coding. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download.

The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for coefficient level coding. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for coefficient level coding may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU), also referred to as “coding tree units,” that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In accordance with the techniques of this disclosure, coding of values representative of whether a coefficient (such as a quantized transform coefficient) is greater than a whole number value (e.g., 1 or 2) may be context modeled using other syntax elements as context. In the current coding scheme of HEVC, the context selection of coeff_abs_level_greater1_flag depends on the values of previous coeff_abs_level_greater1_flags in the same chunk. This characteristic means context selection can only be done after the previous coeff_abs_level_greater1_flag is known and it would limit decoding throughput on entropy decoding, e.g., when coefficients are coded in parallel.

Video encoder 20 and video decoder 30, on the other hand, may be configured to code certain coefficient syntax elements, such as syntax elements representative of whether the coefficient is greater than a whole number (such as one or two) in parallel using other, previously coded syntax elements as context. For example, coding of a value representative of whether a coefficient is greater than one (or greater than two) may depend on values of one or more significant coefficient flags. In various examples, any or all of the following data regarding significant coefficient flags may be used as context when coding the value representative of whether a coefficient is greater than one or two: significant coefficient flags in the current block, significant coefficient flags of neighboring coefficients (within the current chunk or external to the current chunk, e.g., in neighboring chunks), the number of significant coefficient flags, and/or the numbers of significant coefficient flags of each value (e.g., zero or one). Moreover, the context determination may differ between chrominance and luminance components. Using the context, video encoder 20 and video decoder 30 may entropy code data for the syntax elements, e.g., individual bits (also referred to as “bins”), where context generally indicates the probability of a particular bit (or bin) having a value of zero or one.

As an example, signaling (e.g., coding) of the coeff_abs_level_greater_{—}1_flag may depend on the value of a significant_coeff_flag. Thus, as various examples: the context for signaling of coeff_abs_level_greater1_flag may depend on significant_coeff_flag of the coefficients in the block; the signaling of coeff_abs_level_greater1_flag may depend on significant_coeff_flag of the neighboring coefficients (within the chunk or outside of chunk); the signaling of coeff_abs_level_greater1_flag may depend on significant_coeff_flag in the neighboring chunks or the current chuck. In particular, the signaling of coeff_abs_level_greater1_flag depends on the number of significant_coeff_flag; and/or the signaling of coeff_abs_level_greater1_flag may depend on the numbers of significant_coeff_flag being 1 and being 0. In some examples, combinations of one or more of the significant coefficient flags discussed above may be used as context information for coding a coeff_abs_level_greater1_flag.

As noted above, in some examples, the signaling of coeff_abs_level_greater1_flag may depend on the number of significant_coeff_flags. For example, let the number of significant_coeff_flags in a considered region of a block be N. The considered region can be the whole block, neighboring coefficients, the neighboring chunks, or the coefficients in the same chunk. Each coefficient could use different considered regions or some coefficients could share the same considered region. The signaling of coeff_abs_level_greater1_flag of the current coefficient can be predicted from N, or the context modeling of coeff_abs_level_greater1_flag can be a function of N. The function for determining a context for coding the coeff_abs_level_greater1_flag can be a cap, such as min(C, N), where C is a value, and where min (A, B) refers to the minimum value of A and B. Or the function could involve some operations on N, such as min(C, N>>1) or min(C, (N+1)>>1) among many others, where “>>” represents the binary right-shift operator. The function can be different for coefficients associated with residual data for luma component and chroma components. For example, C can be different values for coefficients of a luma block and chroma blocks, or luma may use min(C, N>>1) and chroma may use min(C, N>>2). Again, in some examples, the function may return a context index that corresponds to the context to be used to code coeff_abs_level_greater1_flag.

In the current implementation of HEVC, the luma block has 4 context sets and both chroma blocks have 2 context sets. The index of the context set is still related to the number of coeff_abs_level_greater1_flag in the previous chunk and whether the current chunk is the lowest frequency chunk (in the transform domain). The adopted function is min(C, N>>1), where C=3 for luma and C=2 for chroma. In these examples, C is related to the context number in each context set. N is the number of the significant flags that are before the current coefficient in the scan order inside the current chunk.

As another example, signaling (e.g., coding) of a value representative of whether a coefficient is greater than two, such as coeff_abs_level_greater2_flag, may depend on the values of one or more significant_coeff_flags. In addition, or in the alternative, coding a value for coeff_abs_level_greater2_flag may depend on the values of one or more coeff_abs_level_greater1_flags. Thus, as various examples: the context for signaling of coeff_abs_level_greater2_flag may depend on one or more significant_coeff_flags in the block; the signaling of coeff_abs_level_greater2_flag may depend on significant_coeff_flags of neighboring coefficients within the chunk or outside of chunk; the signaling of coeff_abs_level_greater2_flag may depend on significant_coeff_flags in the neighboring chunks or the current chunk; the signaling of coeff_abs_level_greater2_flag may depend on the number of significant_coeff_flags; the signaling of coeff_abs_level_greater2_flag may depend on the numbers of significant_coeff_flag being 1 and being 0; and the context selection of coeff_abs_level_greater2_flag may depend on the context selection of coeff_abs_level_greater1_flag.

In some examples, combinations of one or more of the significant coefficient flags (and/or the context for the coeff_abs_level_greater1_flag ) discussed above may be used as context information for coding a coeff_abs_level_greater2_flag. In addition, dependency for coefficients of luma components may be different from coefficients of chroma components.

As yet another example, the context for signaling of coeff_abs_level_greater1_flag may depend on previous coeff_abs_level_greater1_flag with delay updated. Another scheme that may improve the throughput is to remove the dependency on the previous decoded N coeff_abs_level_greater1_flag. In these examples, N may be selected as a value representative of the maximum parallel decoding the entropy coder might achieve. That is, the total number of parallel processes may correspond to N+1, such that N represents the number of additional parallel processes.

For example, for a maximum of four parallel processes (e.g., four parallel threads), the signaling of 10^{th} coeff_abs_level_greater1_flag need not depend on the 7^{th} to 9^{th} coeff_abs_level_greater1_flag when N=3; however, signaling of the 10^{th} coeff_abs_level_greater1_flag may depend on the 1^{st} to 6^{th} coeff_abs_level_greater1_flag. Similarly, the signaling of 5^{th} coeff_abs_level_greater1_flag need not depend on the 4^{th} coeff_abs_level_greater1_flag when N=1.

In yet another example, video encoder 20 and video decoder 30 may determine the context for signaling of coeff_abs_level_greater1_flag using the coeff_abs_level_greater1_flag in a previous chunk. That is, video encoder 20 and video decoder 30 may determine the context for coding coeff_abs_level_greater1_flag based on values of one or more coeff_abs_level_greater1_flags for coefficients of one or more previous chunks. For example, a function of values of one or more coeff_abs_level_greater1_flags for coefficients of one or more previous chunks may return a context index for a context to be used to code a current coeff_abs_level_greater1_flag of a current chunk.

In another example, video encoder 20 and video decoder 30 may be configured to add the dependency on decoded coeff_abs_level_greater_{—}1_flags in previous chunks. For example, let numOnes denote a weighted sum of the number of coeff abs level greater 1 flags being equal to one in the previous chunks (e.g., previous chunks of a current TU). The context derivation may depend on the calculated value of numOnes. This technique may be incorporated into one or more of the techniques described above. For example, in the example techniques above relating to functions max(C, N) and min(C, N), and/or the various examples in which the max or min of C and a function of N, the value of C may be related to the context number in each context set. N may be the number of significant flags that occur before a current coefficient in scan order inside a current chunk. The context derivation may be expressed as a function of C, numOnes, and N, such as one of the following equations:

context index=min(C, numOnes+(N>>1) (3)

context index=min(C, (numOnes>0)+(N>>1)) (4)

context index=min(C, (numOnes>>1)+(N>>1)) (5)

context index=min(C, (numOnes+N+1)>>1) (6)

context index=max(C, numOnes+(N>>1) (7)

context index=max(C, (numOnes>0)+(N>>1)) (8)

context index=max(C, (numOnes>>1)+(N>>1)) (9)

context index=max(C, (numOnes+N+1)>>1) (10)

In this manner, video encoder 20 may encode values representative of whether coefficients have level values that exceed a whole number, e.g., one or two, using values of other syntax elements of other coefficients as context information. It should be understood that whole numbers include numeric values one, two, three, and so forth, but exclude zero. The values of the other syntax elements used as context information may include syntax elements from coefficients of the same block, neighboring coefficients of the same chunk, neighboring coefficients outside the current chunk such as from neighboring chunks, a number of significant coefficient flags in the chunk, a number of significant coefficient flags having a particular value (e.g., zero or one), or combinations of such syntax elements. Likewise, video decoder 30 may decode such values in a similar manner. In this manner, the techniques of this disclosure include coding values representative of whether coefficients have level values that exceed a whole number using values of other syntax elements of other coefficients as context information.

In this manner, video encoder 20 and video decoder 30 represent examples of a video coder configured to code a first set of syntax elements for coefficients corresponding to a residual block of video data, and code, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

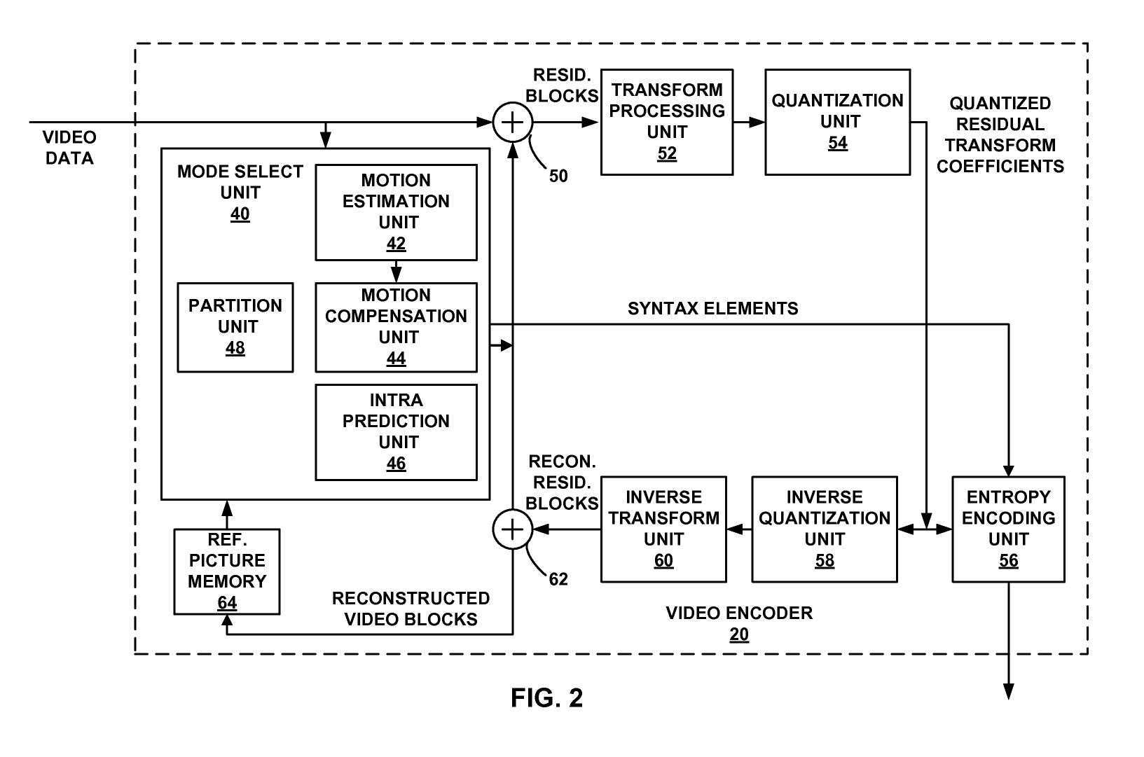

FIG. 2 is a block diagram illustrating an example of video encoder 20 that may implement techniques for coefficient level coding. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 2, video encoder 20 receives a current video block within a video frame to be encoded. In the example of FIG. 2, video encoder 20 includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. Intra-prediction unit 46 may alternatively perform intra-predictive coding of the received video block relative to one or more neighboring blocks in the same frame or slice as the block to be coded to provide spatial compression. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan during entropy coding.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval. In accordance with the techniques of this disclosure, entropy encoding unit 56 may code values representative of whether coefficients have level values that exceed a whole number, e.g., one or two, using values of other syntax elements of other coefficients as context information.

In accordance with the techniques of this disclosure, entropy encoding unit 56 may entropy encode quantized transform coefficients received from quantization unit 54. For ease of explanation, the quantized transform coefficients are simply referred to as “coefficients.” Entropy encoding unit 56 may be configured to encode various syntax elements for the coefficients. For example, entropy encoding unit 56 may be configured to encode a syntax element indicating whether the coefficient has a non-zero level value (and, hence, is significant), such as a significant_coeff_flag. Entropy encoding unit 56 may also be configured to encode a syntax element indicating whether a level value for the coefficient has an absolute value greater than one, such as a coeff_abs_level_greater1_flag.

In accordance with the techniques of this disclosure, entropy encoding unit 56 may be configured to use one or more syntax elements indicating whether respective coefficients have non-zero level values as context information to entropy encode the syntax element indicating whether a level value for a current coefficient has an absolute value greater than one. More particularly, entropy encoding unit 56 may determine a context for coding the syntax element indicating whether a level value for a current coefficient has an absolute value greater than one based on values of one or more previously coded syntax elements, such as syntax elements indicating whether respective coefficients have non-zero level values. This may allow entropy encoding unit 56 to entropy encode one or more syntax elements indicating whether level values for respective coefficients have absolute values greater than one in parallel. That is, by not using syntax elements of the same type as the syntax element to be coded as context data, and instead using syntax elements of a different type, entropy encoding unit 56 may avoid conflicts for determination of context data for coding one or more current syntax elements, where such conflicts may otherwise arise, e.g., due to a syntax element needed for context information not having been parsed or coded yet.

In CABAC, context information generally corresponds to indications of a most probable symbol and a probability of the most probable symbol occurring, when coding binarized values. When entropy encoding a syntax element representing whether a level value of a current coefficient has an absolute value greater than one, entropy encoding unit 56 may select a context using values of one or more syntax elements representing whether respective coefficients have non-zero level values. In other words, the values of one or more previously coded syntax elements may be used to determine a context for entropy encoding a binarized representation of a current syntax element. In addition, the syntax elements used to determine the context may be different types of syntax elements than the current syntax element, such as where the syntax elements used to determine the context represent whether respective coefficients have non-zero level values, whereas the current syntax element may represent whether a level value for a current coefficient has an absolute value greater than one.

In the example above, syntax elements representing whether coefficients are significant (i.e., have non-zero values) are used to determine context for entropy encoding a syntax element representing whether a level value for a current coefficient has an absolute value that is greater than one. Thus, this represents one example of two different types of syntax elements, in which syntax elements of a first type corresponding to a residual block of video data are used to determined context data to code syntax elements of a second, different type for the coefficients. Another example of such different types of syntax elements being used in this manner is that the syntax elements representing whether coefficients are significant (i.e., have non-zero values) may be used to determine context for entropy encoding a syntax element representing whether a level value for a current coefficient has an absolute value that is greater than two. Additionally or alternatively, in yet another example, syntax elements representing whether level values for respective coefficients have absolute values that are greater than one may be used to determine context for entropy encoding a syntax element representing whether a level value for a current coefficient has an absolute value that is greater than two.

Entropy encoding unit 56 may be configured to use syntax elements of the first type as context data for coding a syntax element of the second type in various ways. For example, let significant_coeff_flag represent a syntax element indicating whether a coefficient is significant, and let coeff_abs_level_greater1_flag represent a syntax element indicating whether a level value for a coefficient has an absolute value that is greater than one. Entropy encoding unit 56 may be configured according to any or all of the following examples, alone or in any combination. The term “depend on” in the examples below should be understood to mean “use as context data.”

The signaling (that is, entropy encoding) of coeff_abs_level_greater1_flag for a current coefficient of a block may depend on one or more significant_coeff_flags in the block, that is, for one or more coefficients. The signaling of coeff_abs_level_greater1_flag for a current coefficient may depend on one or more significant_coeff_flags of one or more neighboring coefficients (e.g., within a chunk including the current coefficient, and/or outside of the chunk). The signaling of coeff_abs_level_greater1_flag for a current coefficient may depend on a significant_coeff_flag of a coefficient in a neighboring chunk or the current chuck. The signaling of coeff_abs_level_greater1_flag for a current coefficient may depend on the number of significant_coeff_flags, e.g., the total number of significant coefficient flags that are available (e.g., within the current chunk or block) and/or the number of significant coefficient flags of a particular value, e.g., 0 or 1. The signaling of coeff_abs_level_greater1_flag for a current coefficient may depend on both the number of significant_coeff_flags of one or more coefficients having values of 1 and the number of significant_coeff_flags of one or more coefficients having values of 0.

In this manner, the signaling (that is, entropy encoding) of coeff_abs_level_greater1_flag may depend on (that is, use as context data) data related to one or more significant_coeff_flags of one or more respective coefficients. For example, let the number of significant_coeff_flags in a considered region of a block be N. The considered region can be the whole block, neighboring coefficients, the neighboring chunks, or the coefficients in the same chunk. Entropy encoding unit 56 may use, for each coefficient, different considered regions, or some coefficients could share the same considered region. The signaling of coeff_abs_level_greater1_flag of the current coefficient can be predicted from N, or the context modeling of coeff_abs_level_greater1_flag can be a function of N. The function can be a cap, such as max(C, N), where C is a predetermined value. Or the function could involve some operations on N, such as max(C, N>>1) or max(C, (N+1)>>1) among many others. The function can be different for luma component and chroma components. For example, entropy encoding unit 56 may utilize a different value for C when coding a coefficient of a luma component than when coding a coefficient of a chroma component. Additionally or alternatively, entropy encoding unit 56 may use max(C, N>>1) to code a luma coefficient and use max(C, N>>2)) to code a chroma coefficient.

As another example, let coeff_abs_level_greater2_flag represent a syntax element indicating whether a level value for a coefficient has an absolute value that is greater than two. Entropy encoding unit 56 may be configured according to any or all of the following examples, alone or in any combination, which may also be in addition to or in the alternative to the examples discussed above with respect to coding coeff_abs_level_greater2_flag.

The signaling (that is, entropy encoding) of coeff_abs_level_greater2_flag of a current coefficient of a block of video data may depend on significant_coeff_flags of one or more coefficients in the block. The signaling of coeff_abs_level_greater2_flag for a current coefficient may depend on significant_coeff_flags of one or more neighboring coefficients (e.g., within a chunk including the current coefficient or outside of chunk). The signaling of coeff_abs_level_greater2_flag for a current coefficient may depend on significant_coeff_flags of one or more coefficients in one or more neighboring chunks and/or of the current chunk. The signaling of coeff_abs_level_greater2_flag for a current coefficient may depend on the number of significant_coeff_flags. The signaling of coeff_abs_level_greater2_flag for a current coefficient may depend on the number of significant_coeff_flags having values of 1 and the number of significant_coeff_flags having values of 0. Dependency for luma component may be different from chroma components. The context selection of coeff_abs_level_greater2_flag may depend on the context selection of coeff_abs_level_greater1_flag. Additionally or alternatively, signaling of coeff_abs_level_greater2_flag may depend on various data related to coeff_abs_level_greater1_flag, e.g., by substituting “coeff_abs_level_greater1_flag” for “significant_coeff_flag” in any of the examples above.

In addition, or in the alternative, entropy encoding unit 56 may be configured to code coeff_abs_level_greater1_flag using previously coded coeff_abs_level_greater1_flags as context information. However, selection of the previously coded coeff_abs_level_greater1_flags for use as context information may depend on the number of available parallel processes. For example, assuming that there are N parallel processes, the current coeff_abs_level_greater1_flag is for the X^{th} coefficient, and M coefficients are used for context information, entropy encoding unit 56 may determine context for entropy encoding the current coeff_abs_level_greater1_flag using values of the coeff_abs_level_greater1_flags for coefficients at positions (X−N), (X−N−1), (X−N−2), . . . , (X−N−(M−1)). The position (X−N−(N−1)) may also be expressed as (X−N−M+1).

Thus, if there are four parallel processes available, entropy encoding unit 56 may use the values of coeff_abs_level_greater1_flags for coefficients at positions (X−4), (X−5), (X−6), and (X−7) as context information for coding the coeff_abs_level_greater1_flag at current position X. In this manner, entropy encoding unit 56 may, using other parallel processes, code coeff_abs_level_greater1_flags for coefficients at positions (X−1), (X−2), and (X−3) in parallel. Thus, each of the coeff_abs_level_greater1_flags for coefficients at positions X, (X−1), (X−2), and (X−3) may be considered “current,” but the coeff_abs_level_greater1_flag at position X may be considered the current coeff_abs_level_greater1_flag for a particular process (e.g., a particular parallel hardware processing unit or software thread). The “positions” in these examples correspond to positions in scan order, that is, the order in which the syntax elements for the coefficients are entropy encoded.

Although the example above regarding selection of context based on a number of parallel processes available was described with respect to coding of coeff_abs_level_greater1_flags, it should be understood that entropy encoding unit 56 may be configured to code other syntax elements using substantially similar techniques. For example, entropy encoding unit 56 may be configured to code significant_coeff_flags and/or coeff_abs_level_greater2_flags using similar techniques to those described above.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

In this manner, video encoder 20 of FIG. 2 represents an example of a video encoder configured to calculate level values for coefficients of a residual block of video data, code a first set of syntax elements for the coefficients, and code, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

Likewise, video encoder 20 also represents an example of a video encoder configured to entropy encode two or more current syntax elements for a set of N coefficients of a block of video data substantially in parallel using syntax elements for one or more coefficients of the video block that are at least N positions away from the current syntax elements as context information.

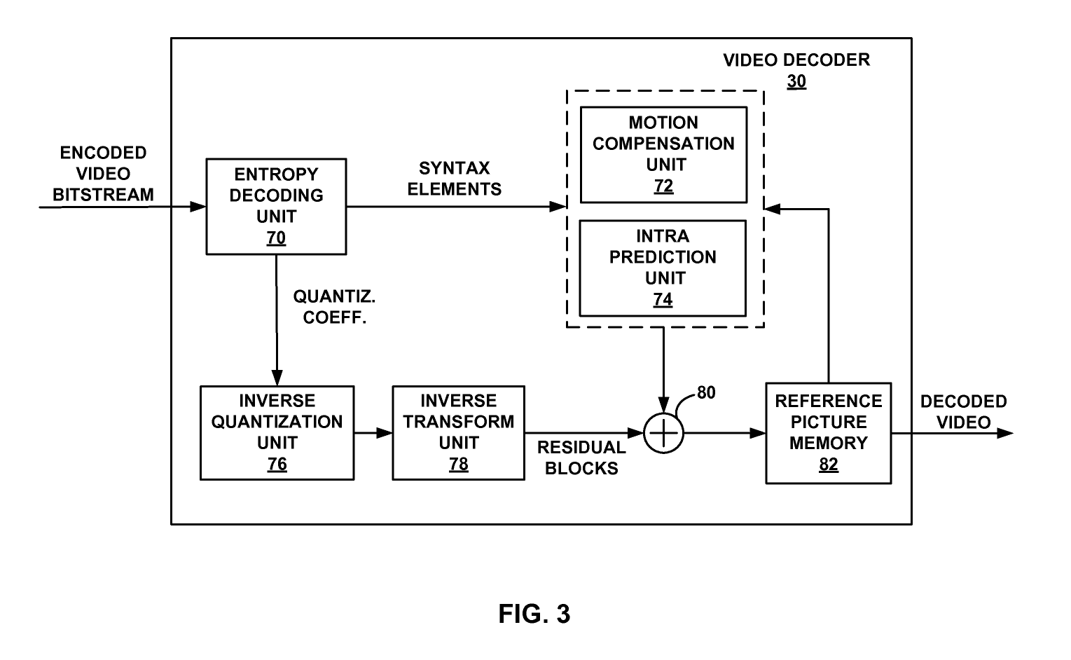

FIG. 3 is a block diagram illustrating an example of video decoder 30 that may implement techniques for coefficient level coding. In the example of FIG. 3, video decoder 30 includes an entropy decoding unit 70, motion compensation unit 72, intra prediction unit 74, inverse quantization unit 76, inverse transformation unit 78, reference picture memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors and other syntax elements to motion compensation unit 72. Video decoder 30 may receive the syntax elements at the video slice level and/or the video block level. In addition, in accordance with the techniques of this disclosure, entropy decoding unit 70 may code values representative of whether coefficients have level values that exceed a whole number, e.g., one or two, using values of other syntax elements of other coefficients as context information.

In accordance with the techniques of this disclosure, entropy decoding unit 70 may entropy decode data representing quantized transform coefficients received in the bitstream. For ease of explanation, the quantized transform coefficients are simply referred to as “coefficients.” Entropy decoding unit 70 may be configured to decode various syntax elements for the coefficients. For example, entropy decoding unit 70 may be configured to decode data to reproduce a syntax element indicating whether the coefficient has a non-zero level value (and, hence, is significant), such as a significant_coeff_flag. Entropy decoding unit 70 may also be configured to decode data to reproduce a syntax element indicating whether a level value for the coefficient has an absolute value greater than one, such as a coeff_abs_level_greater1_flag.

In accordance with the techniques of this disclosure, entropy decoding unit 70 may be configured to use one or more syntax elements indicating whether respective coefficients have non-zero level values as context information to entropy decode the syntax element indicating whether a level value for a current coefficient has an absolute value greater than one. More particularly, entropy decoding unit 70 may determine a context for coding the syntax element indicating whether a level value for a current coefficient has an absolute value greater than one based on values of one or more previously coded syntax elements, such as syntax elements indicating whether respective coefficients have non-zero level values. This may allow entropy decoding unit 70 to entropy decode one or more syntax elements indicating whether level values for respective coefficients have absolute values greater than one in parallel. That is, by not using syntax elements of the same type as context data, entropy decoding unit 70 may avoid conflicts for determination of context data for coding one or more current syntax elements, where such conflicts may otherwise arise, e.g., due to a syntax element needed for context information not having been parsed or coded yet.

As noted above, in CABAC, context information generally corresponds to indications of a most probable symbol and a probability of the most probable symbol occurring, when decoding data to reproduce a binarized value for a syntax element, where the binarized value may further be converted to the syntax element itself. When entropy decoding data to reproduce a syntax element representing whether a level value of a current coefficient has an absolute value greater than one, entropy decoding unit 70 may select a context using values of one or more syntax elements representing whether respective coefficients have non-zero level values. In other words, the values of one or more previously coded syntax elements may be used to determine a context for entropy decoding a binarized representation of a current syntax element. In addition, the syntax elements used to determine the context may be different types of syntax elements than the current syntax element, such as where the syntax elements used to determine the context represent whether respective coefficients have non-zero level values, whereas the current syntax element may represent whether a level value for a current coefficient has an absolute value greater than one.

In the example above, syntax elements representing whether coefficients are significant (i.e., have non-zero values) are used to determine context for entropy decoding a syntax element representing whether a level value for a current coefficient has an absolute value that is greater than one. Thus, this represents one example of two different types of syntax elements, in which syntax elements of a first type corresponding to a residual block of video data are used as context data to code syntax elements of a second, different type for the coefficients. Another example of such different types of syntax elements being used in this manner is that the syntax elements representing whether coefficients are significant (i.e., have non-zero values) may be used to determine context for entropy decoding a syntax element representing whether a level value for a current coefficient has an absolute value that is greater than two. Additionally or alternatively, in yet another example, syntax elements representing whether level values for respective coefficients have absolute values that are greater than one may be used to determine context for entropy decoding a syntax element representing whether a level value for a current coefficient has an absolute value that is greater than two.

Entropy decoding unit 70 may be configured to use syntax elements of the first type as context data for decoding a syntax element of the second type in various ways. For example, let significant_coeff_flag represent a syntax element indicating whether a coefficient is significant, and let coeff_abs_level_greater1_flag represent a syntax element indicating whether a level value for a coefficient has an absolute value that is greater than one. Entropy decoding unit 70 may be configured according to any or all of the following examples, alone or in any combination. The term “depend on” in the examples below should be understood to mean “use as context data.”

The signaling (that is, entropy decoding) of coeff_abs_level_greater1_flag for a current coefficient of a block may depend on one or more significant_coeff_flags in the block, that is, for one or more coefficients. The signaling of coeff_abs_level_greater1_flag for a current coefficient may depend on one or more significant_coeff_flags of one or more neighboring coefficients (e.g., within a chunk including the current coefficient, and/or outside of the chunk). The signaling of coeff_abs_level_greater1_flag for a current coefficient may depend on a significant_coeff_flag of a coefficient in a neighboring chunk or the current chuck. The signaling of coeff_abs_level_greater1_flag for a current coefficient may depend on the number of significant_coeff_flags, e.g., the total number of significant coefficient flags that are available (e.g., within the current chunk or block) and/or the number of significant coefficient flags of a particular value, e.g., 0 or 1. The signaling of coeff_abs_level_greater1_flag for a current coefficient may depend on both the number of significant_coeff_flags of one or more coefficients having values of 1 and the number of significant_coeff_flags of one or more coefficients having values of 0.

In this manner, the signaling (that is, entropy decoding) of coeff_abs_level_greater1_flag may depend on (that is, use as context data) data related to one or more significant_coeff_flags of one or more respective coefficients. For example, let the number of significant_coeff_flags in a considered region of a block be N. The considered region can be the whole block, a group of neighboring coefficients, one or more of the neighboring chunks, or some or all of the coefficients in the same chunk. Entropy decoding unit 70 may use, for each coefficient, different considered regions, or some coefficients could share the same considered region. The signaling of coeff_abs_level_greater1_flag of the current coefficient can be predicted from N, or the context modeling of coeff_abs_level_greater1_flag can be a function of N. The function can be a cap, such as max(C, N), where C is a predetermined value. Or the function could involve some operations on N, such as max(C, N>>1) or max(C, (N+1)>>1) among many others. The function can be different for luma component and chroma components. For example, entropy decoding unit 70 may utilize a different value for C when coding a coefficient of a luma component than when coding a coefficient of a chroma component. Additionally or alternatively, entropy decoding unit 70 may use max(C, N>>1) to code a luma coefficient and use max(C, N>>2)) to code a chroma coefficient.

As another example, let coeff_abs_level_greater2_flag represent a syntax element indicating whether a level value for a coefficient has an absolute value that is greater than two. Entropy decoding unit 70 may be configured according to any or all of the following examples, alone or in any combination, which may also be in addition to or in the alternative to the examples discussed above with respect to coding coeff_abs_level_greater2_flag.

The signaling (that is, entropy decoding) of coeff_abs_level_greater2_flag of a current coefficient of a block of video data may depend on significant_coeff_flags of one or more coefficients in the block. The signaling of coeff_abs_level_greater2_flag for a current coefficient may depend on significant_coeff_flags of one or more neighboring coefficients (e.g., within a chunk including the current coefficient or outside of chunk). The signaling of coeff_abs_level_greater2_flag for a current coefficient may depend on significant_coeff_flags of one or more coefficients in one or more neighboring chunks and/or of the current chunk. The signaling of coeff_abs_level_greater2_flag for a current coefficient may depend on the number of significant_coeff_flags. The signaling of coeff_abs_level_greater2_flag for a current coefficient may depend on the number of significant_coeff_flags having values of 1 and the number of significant_coeff_flags having values of 0. Dependency for luma components may be different from chroma components. The context selection of coeff_abs_level_greater2_flag may depend on the context selection of coeff_abs_level_greater1_flag. Additionally or alternatively, signaling of coeff_abs_level_greater2_flag may depend on various data related to coeff_abs_level_greater1_flag, e.g., by substituting “coeff_abs_level_greater1_flag” for “significant_coeff_flag” in any of the examples above.

In addition, or in the alternative, entropy decoding unit 70 may be configured to code coeff_abs_level_greater1_flag using previously coded coeff_abs_level_greater1_flags as context information. However, selection of the previously coded coeff_abs_level_greater1_flags for use as context information may depend on the number of available parallel processes. For example, assuming that there are N parallel processes, the current coeff_abs_level_greater1_flag is for the X^{th} coefficient, and M coefficients are used for determining context information, entropy decoding unit 70 may determine context for entropy decoding the current coeff_abs_level_greater1_flag using values of the coeff_abs_level_greater1_flags for coefficients at positions (X−N), (X−N−1), (X−N−2), . . . , (X−N−(M−1)). Again, (X−N−(M−1)) may also be expressed as (X−N−M+1).

Thus, if there are four parallel processes available, entropy decoding unit 70 may use the values of coeff_abs_level_greater1_flags for coefficients at positions (X−4), (X−5), (X−6), and (X−7) as context information for coding the coeff_abs_level_greater1_flag at current position X. In this manner, entropy decoding unit 70 may, using other parallel processes, code coeff_abs_level_greater1_flags for coefficients at positions (X−1), (X−2), and (X−3) in parallel. Thus, each of the coeff_abs_level_greater1_flags for coefficients at positions X, (X−1), (X−2), and (X−3) may be considered “current,” but the coeff_abs_level_greater1_flag at position X may be considered the current coeff_abs_level_greater1_flag for a particular process (e.g., a particular parallel hardware processing unit or software thread). The “positions” in these examples correspond to positions in scan order, that is, the order in which the syntax elements for the coefficients are entropy decoded.

Although the example above regarding selection of context based on a number of parallel processes available was described with respect to coding of coeff_abs_level_greater1_flags, it should be understood that entropy decoding unit 70 may be configured to code other syntax elements using substantially similar techniques. For example, entropy decoding unit 70 may be configured to code significant_coeff_flags and/or coeff_abs_level_greater2_flags using similar techniques to those described above.

In this manner, entropy decoding unit 70 may entropy decode syntax elements for quantized transform coefficients. As explained below, video decoder 30 inverse quantizes and inverse transforms such coefficients. In addition, entropy decoding unit 70 may entropy decode syntax elements relating to prediction information, such as motion information and/or intra-prediction mode information. Entropy decoding unit 70 provides such prediction information to motion compensation unit 72 and/or intra prediction unit 74.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 80. The inverse quantization process may include use of a quantization parameter QPY calculated by video decoder 30 for each video block in the video slice to determine a degree of quantization and, likewise, a degree of inverse quantization that should be applied. Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference picture memory 82 also stores decoded video for later presentation on a display device, such as display device 32 of FIG. 1.

In this manner, video decoder 30 of FIG. 3 represents an example of a video decoder configured to code a first set of syntax elements for coefficients corresponding to a residual block of video data, and code, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

Likewise, video decoder 30 also represents an example of a video decoder configured to entropy encode two or more current syntax elements for a set of N coefficients of a block of video data substantially in parallel using syntax elements for one or more coefficients of the video block that are at least N positions away from the current syntax elements as context information.

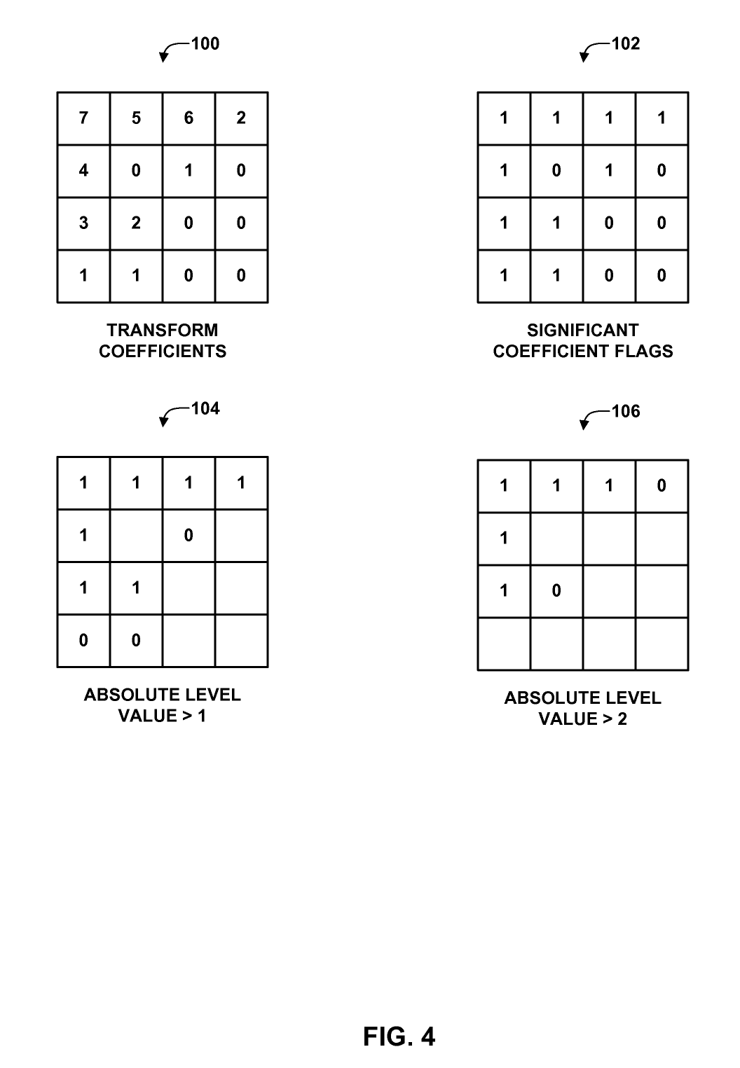

FIG. 4 is a conceptual diagram illustrating various syntax elements for a block of transform coefficients. In particular, the example of FIG. 4 illustrates block 100 including various transform coefficients. In particular, the coefficients represent examples of quantized transform coefficients, but are referred to as “coefficients” for ease of explanation. In the example of block 100, the coefficients include (from left-to-right, top-to-bottom) 7, 5, 6, 2, 4, 0, 1, 0, 3, 2, 0, 0, 1, 1, 0, and 0. Video coders, such as video encoder 20 and video decoder 30, may be configured to code syntax elements representative of these coefficients using CABAC, in accordance with the techniques of this disclosure.

For example, video encoder 20 and video decoder 30 may be configured to code syntax elements representative of whether the coefficients of block 100 have a non-zero value, i.e., are significant. As discussed above, such syntax elements may be referred to as significant_coeff_flags. Block 102 represents an example of a block including such significant_coeff_flags, also sometimes referred to as a “significance map.” Proceeding in the same order as for block 100, block 102 has values of 1, 1, 1, 1, 1, 0, 1, 0, 1, 1, 0, 0, 1, 1, 0, and 0. Video encoder 20 and video decoder 30 may be configured to code each of these syntax elements for the respective coefficients of block 100. For example, video encoder 20 and video decoder 30 may code the significant_coeff_flags of block 102 using conventional coding techniques of the upcoming HEVC standard or other relevant coding standard.

Alternatively, video encoder 20 and video decoder 30 may be configured to code the significant_coeff_flags in accordance with the techniques of this disclosure, e.g., to code the significant_coeff_flags in parallel. For example, video encoder 20 and video decoder 30 may be configured to determine a number of parallel processes available, N, and to use one or more previously coded significant_coeff_flags that are at least N coefficients away, in scan order, from a current significant_coeff_flag as context information for coding the current significant_coeff_flag.

As an example, suppose that N is equal to 4. Assume that the coding order of the coefficients is a zig-zag pattern that proceeds from the bottom-right syntax element of block 102 to the top-left syntax element, and that the current syntax elements for one of the four processes is the significant_coeff_flag having a value of “0” at position (1, 1) of block 102, where position (0, 0) corresponds to the top-left position of block 102 (and thus, position (1, 1) corresponds to the last non-significant coefficient of block 100). In this example, video encoder 20 and video decoder 30 may avoid using significant_coeff_flags at positions (2, 0), (3, 0), and (2, 1) as context data for coding the significant_coeff_flag at position (1, 1), because each of these significant_coeff_flags could potentially be coded in parallel. Therefore, video encoder 20 and video decoder 30 may use any or all of the significant_coeff_flags at positions (1, 2), (0, 3), (1, 3), (2, 2), (3, 1), (3, 2), (2, 3), and (3, 3), alone or in any combination, as syntax data for coding the significant_coeff_flag at position (1, 1). Video encoder 20 and video decoder 30 may be configured to code coeff_abs_level_greater1_flag (e.g., syntax elements of block 104) and/or coeff_abs_level_greater2_flag (e.g., syntax elements of block 106) in a substantially similar manner.

As discussed above, the syntax elements of block 102 represent a particular type of syntax element, namely, a syntax element indicating whether a corresponding coefficient is significant, i.e., has a non-zero level value. Video encoder 20 and video decoder 30 may be configured to further code values representing whether level values of significant coefficients have absolute values greater than one. Such syntax elements are shown in the example of block 104, and represent a different type of syntax element than the significant_coeff_flag discussed above.

In this example, again following the same order as discussed with respect to block 100, block 104 includes syntax elements having values of 1, 1, 1, 1, 1, 0, 1, 1, 0, 0. It should be understood that values for the non-significant coefficients need not be coded. That is, video decoder 30 may infer that coefficients having a value of 0, as indicated by the corresponding significant_coeff_flags, also have absolute level values equal to 0, and hence, not greater than one. Accordingly, video encoder 20 and video decoder 30 need only code coeff_abs_level_greater1_flags for coefficients at positions (0, 0), (1, 0), (2, 0), (3, 0), (0, 1), (2, 1), (0, 2), (1, 2), (0, 3), and (1, 3), in the example of FIG. 4.

In accordance with the techniques of this disclosure, video encoder 20 and video decoder 30 may use the values of one or more of the significant_coeff_flags of block 102 as context information for coding the syntax elements (that is, coeff_abs_level_greater1_flags) of block 104. In this manner, video encoder 20 and video decoder 30 can code one or more of the coeff_abs_level_greater1_flags of block 104 in parallel, without the risk that context data is not available, because the context data will have been previously coded (due to block 102 being coded prior to block 104).

Likewise, block 106 represents an example set of syntax elements indicating whether respective coefficients have absolute level values greater than 2. Again, for those coefficients that do not have absolute level values greater than 1 as indicated by block 104 (which includes non-significant coefficients, as indicated by block 102), no syntax elements need be coded, as video decoder 30 can infer that a coefficient having a non-significant value or an absolute level value that is not greater than 1 also does not have an absolute level value greater than two. Thus, values of 0 can be inferred for such coeff_abs_level_greater2_flags. In this example, again following the same order as discussed with respect to block 100, block 106 includes syntax elements having values of 1, 1, 1, 0, 1, 1, 0.

In accordance with the techniques of this disclosure, video encoder 20 and video decoder 30 may use the values of one or more of the coeff_abs_level_greater1_flags of block 104 as context information for coding the syntax elements (that is, coeff_abs_level_greater2_flags) of block 106. Additionally or alternatively, video encoder 20 and video decoder 30 may be configured to use the values of one or more of the coeff_abs_level_greater1_flags of block 104 as context information for coding the syntax elements (that is, coeff_abs_level_greater2_flags) of block 106. In this manner, video encoder 20 and video decoder 30 can code one or more of the coeff_abs_level_greater2_flags of block 106 in parallel, without the risk that context data is not available, because the context data will have been previously coded (i.e., due to blocks 102 and 104 being coded prior to block 106).

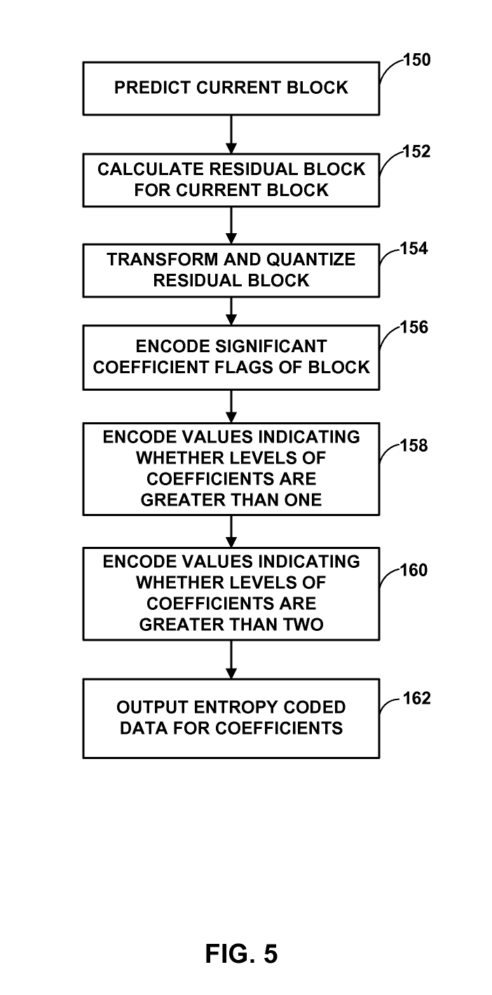

FIG. 5 is a flowchart illustrating an example method for encoding a current block. The current block may comprise a current CU or a portion of the current CU. Although described with respect to video encoder 20 (FIGS. 1 and 2), it should be understood that other devices may be configured to perform a method similar to that of FIG. 5.

In this example, video encoder 20 initially predicts the current block (150). For example, video encoder 20 may calculate one or more prediction units (PUs) for the current block. Video encoder 20 may then calculate a residual block for the current block, e.g., to produce a transform unit (TU) (152). To calculate the residual block, video encoder 20 may calculate a difference between pixel values of the original, uncoded block and pixel values of the predicted block for the current block, producing residual values. Video encoder 20 may then transform the residual values to form transform coefficients, and quantize the coefficients of the residual block (154). In this manner, video encoder 20 may form quantized transform coefficients for the residual block, also simply referred to as coefficients.

As noted above, video encoder 20 may code five syntax elements for each of the coefficients: significant_coeff_flag, coeff_abs_level_greater1_flag, coeff_abs_level_greater2_flag, coeff_sign_flag, and coeff_abs_level_minus3. Thus, as shown in FIG. 5, video encoder 20 may encode significant coefficient flags of the block (156). Video encoder 20 may also encode values indicating whether level values (or absolute values of the level values) of the coefficients are greater than one (158), e.g., coeff_abs_level_greater1_flags. In particular, video encoder 20 may encode a plurality of the values indicating whether level values (or absolute values of the level values) of the coefficients are greater than one substantially in parallel.

In coding the values indicating whether level values (or absolute values of the level values) of the coefficients are greater than one, video encoder 20 may use one or more of the values of the significant coefficient flags coded at step (156) as context information. That is, video encoder 20 may use the values of the significant coefficient flags to determine context information, such as the probability that a coeff_abs_level_greater1_flag will have a value of 0 or 1. Video encoder 20 may further code the coeff_abs_level_greater1_flag using the context information.

In this manner, the significant coefficient flags and the values indicating whether absolute values of the level values of the coefficients are greater than one represent two different types of syntax elements for coefficients of a block of video data. That is, significant_coeff_flag is a different type of syntax element than coeff_abs_level_greater1_flag. Likewise, as explained below, coeff_abs_level_greater2_flag is a different type of syntax element than both coeff_abs_level_greater1_flag and significant_coeff_flag.

Video encoder 20 may further encode values indicating whether level values (or absolute values of the level values) of the coefficients are greater than two (160), e.g., coeff_abs_level_greater2_flags. In coding the values indicating whether level values (or absolute values of the level values) of the coefficients are greater than two, video encoder 20 may use one or more of the values of the significant coefficient flags coded at step (156) and/or one or more of the values indicating whether level values (or absolute values of the level values) of the coefficients are greater than one coded at step (158) as context information. In particular, video encoder 20 may encode a plurality of the values indicating whether level values (or absolute values of the level values) of the coefficients are greater than two substantially in parallel.

That is, video encoder 20 may use the values of the significant coefficient flags and/or the values indicating whether level values (or absolute values of the level values) of the coefficients are greater than one to determine context information, such as the probability that a coeff_abs_level_greater2_flag will have a value of 0 or 1. Video encoder 20 may further code the coeff_abs_level_greater2_flag using the context information.

Alternatively, rather than using syntax elements of different types as context information, entropy encoding unit 56 may use previously coded syntax elements of the same type as context information, but may take account of a number of parallel processes to select which syntax elements to use as context information. For example, entropy encoding unit 56 may determine a number N of parallel processes available and select only syntax elements having positions that are at least N away from the position of the current syntax element, in scanning/coding order, as context information. Entropy encoding unit 56 may select the context information using such syntax elements in this manner for coding any or all of the significant coefficient flags (per step (156) of FIG. 5), syntax elements indicating whether absolute level values for coefficients are greater than one (per step (158) of FIG. 5), or syntax elements indicating whether absolute level values for coefficients are greater than two (per step (160) of FIG. 5).

Furthermore, video encoder 20 may encode the other syntax elements discussed above, although not shown in FIG. 5. Moreover, video encoder 20 may output entropy coded data for the coefficients (162), e.g., the entropy coded syntax elements significant_coeff_flag, coeff_abs_level_greater1_flag, coeff_abs_level_greater2_flag, coeff_sign_flag, and coeff_abs_level_minus3.

In this manner, the method of FIG. 5 represents an example of a method including coding a first set of syntax elements for coefficients corresponding to a residual block of video data, and coding, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

Likewise, coding the first set of syntax elements may include encoding the first set of syntax elements, and coding the second set of syntax elements may include encoding the second set of syntax elements. The first type of syntax elements may correspond to significant coefficient flags, in which case the second type of syntax elements may correspond to syntax elements indicating whether level values for the coefficients have absolute values greater than one (or two). Alternatively, the first type of syntax elements may correspond to values indicating whether level values for the coefficients have absolute values greater than one, in which case the second type of syntax elements may correspond to values indicating whether level values for the coefficients have absolute values greater than two.

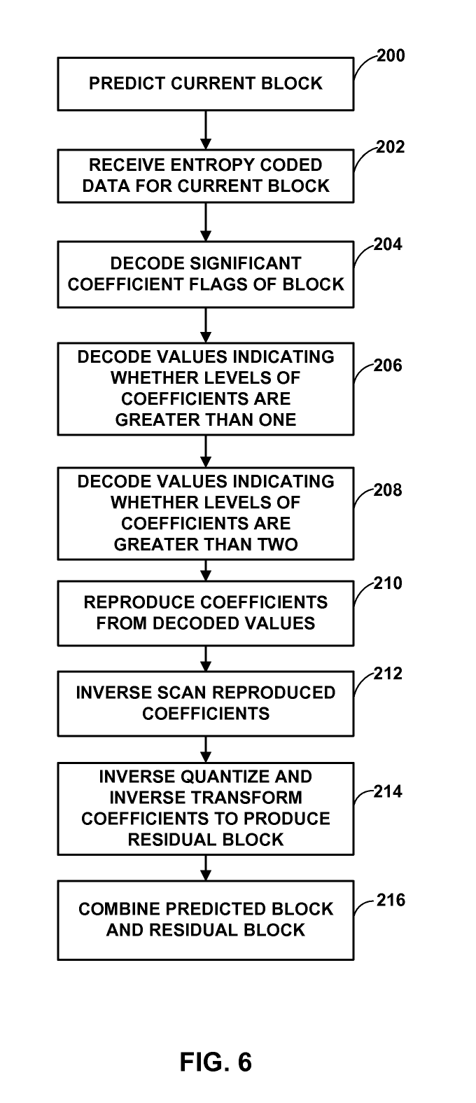

FIG. 6 is a flowchart illustrating an example method for decoding a current block of video data. The current block may comprise a current CU or a portion of the current CU. Although described with respect to video decoder 30 (FIGS. 1 and 3), it should be understood that other devices may be configured to perform a method similar to that of FIG. 6.

Video decoder 30 may predict the current block (200), e.g., using an intra- or inter-prediction mode to calculate a predicted block for the current block. Video decoder 30 may also receive entropy coded data for the current block, such as entropy coded data for coefficients of a residual block corresponding to the current block (202). As an example, video decoder 30 may receive entropy coded values for syntax elements significant_coeff_flag, coeff_abs_level_greater1_flag, coeff_abs_level_greater2_flag, coeff_sign_flag, and coeff_abs_level_minus3.

Video decoder 30 may decode the significant coefficient flags of the block (204). Video decoder 30 may also decode values indicating whether levels (or absolute values of the levels) of the coefficients are greater than one (206), e.g., coeff_abs_level_greater1_flags. In decoding the values indicating whether levels (or absolute values of the levels) of the coefficients are greater than one, video decoder 30 may use one or more of the values of the significant coefficient flags coded at step (204) as context information. In particular, video decoder 30 may decode a plurality of the values indicating whether level values (or absolute values of the level values) of the coefficients are greater than one substantially in parallel.

Video decoder 30 may further decode values indicating whether levels (or absolute values of the levels) of the coefficients are greater than two (208), e.g., coeff_abs_level_greater2_flags. In particular, video decoder 30 may decode a plurality of the values indicating whether level values (or absolute values of the level values) of the coefficients are greater than two substantially in parallel. In decoding the values indicating whether levels (or absolute values of the levels) of the coefficients are greater than two, video decoder 30 may use one or more of the values of the significant coefficient flags coded at step (204) and/or one or more of the values indicating whether levels (or absolute values of the levels) of the coefficients are greater than one coded at step (206) as context information.

Alternatively, rather than using syntax elements of different types as context information, entropy decoding unit 70 may use previously coded syntax elements of the same type as context information, but may take account of a number of parallel processes to select which syntax elements to use as context information. For example, entropy decoding unit 70 may determine a number N of parallel processes available and select only syntax elements having positions that are at least N away from the position of the current syntax element, in scanning/coding order, as context information. Entropy decoding unit 70 may select the context information using such syntax elements in this manner for coding any or all of the significant coefficient flags (per step (204) of FIG. 6), syntax elements indicating whether absolute level values for coefficients are greater than one (per step (206) of FIG. 6), or syntax elements indicating whether absolute level values for coefficients are greater than two (per step (208) of FIG. 6).

Furthermore, video decoder 30 may decode the other syntax elements discussed above, although not shown in FIG. 6. For example, video decoder 30 may decode syntax elements representative of signs for the coefficients (e.g., coeff_sign_flags) and remaining absolute level values (e.g., coeff_abs_level_minus3) for the coefficients having absolute level values greater than two. Video decoder 30 may then reproduce the coefficients from the decoded values (210) and inverse scan the reproduced coefficients (212) to reproduce a block of quantized transform coefficients. Video decoder 30 may then inverse quantize and inverse transform the coefficients to produce a residual block (214). Video decoder 30 may ultimately decode the current block by combining the predicted block and the residual block (216) to reconstruct a representation of the original video block.

In this manner, the method of FIG. 6 represents an example of a method including coding a first set of syntax elements for coefficients corresponding to a residual block of video data, and coding, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients. In the example of FIG. 6, coding the first set of syntax elements may include decoding the first set of syntax elements, coding the second set of syntax elements may include decoding the second set of syntax elements, and calculating the level values may include reproducing the level values using the decoded first set of syntax elements and the decoded second set of syntax elements.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
coding a first set of syntax elements for coefficients corresponding to a residual block of video data; and
coding, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

2. The method of claim 1, wherein the first set of syntax elements comprises significant coefficient flags of the coefficients.

3. The method of claim 2, wherein the second set of syntax elements comprise values representative of whether level values for the respective coefficients have absolute values that exceed one.

4. The method of claim 3, wherein the second set of syntax elements comprise ceoff_abs_level_greater1_flags of the coefficients.

5. The method of claim 2, wherein the second set of syntax elements comprise values representative of whether level values for the respective coefficients have absolute values that exceed two.

6. The method of claim 5, wherein the second set of syntax elements comprise ceoff_abs_level_greater2_flags of the coefficients.

7. The method of claim 5, wherein coding the second set of syntax elements comprises coding the second set of syntax elements additionally using values representative of whether the level values for the coefficients have absolute values that exceed one as context data.

8. The method of claim 1, wherein the first set of syntax elements comprise values representative of whether level values for the coefficients have absolute values that exceed one, and wherein the second set of syntax elements comprise values representative of whether the level values for the respective coefficients have absolute values that exceed two.

9. The method of claim 8, wherein the first set of syntax elements comprise ceoff_abs_level_greater1_flags of the coefficients, and wherein the second set of syntax elements comprise ceoff_abs_level_greater2_flags of the coefficients.

10. The method of claim 1, wherein using at least a portion of the first set of syntax elements as context data comprises using one or more of the first set of syntax elements of a common block, the first set of syntax elements of neighboring coefficients within a current chunk, the first set of syntax elements of neighboring coefficients outside of the current chunk, the first set of syntax elements in a neighboring chunk, the first set of syntax elements in the current chunk, a number of elements in the first set of syntax elements, and a number of elements in the first set of syntax elements having a particular value.

11. The method of claim 10, wherein the first set of syntax elements comprises significant coefficient flags of the coefficients and wherein using the at least portion of the first set of syntax elements as context data comprises using a first value representing a number of the significant coefficient flags having a value of one and a second value representing a number of the significant coefficient flags having a value of zero.

12. The method of claim 10, wherein the coefficients comprise coefficients of a luminance component, wherein using the at least portion of the first set of syntax elements comprises using a first combination of the first set of syntax elements of a common block, the first set of syntax elements of neighboring coefficients within a current chunk, the first set of syntax elements of neighboring coefficients outside of the current chunk, the first set of syntax elements in a neighboring chunk, the first set of syntax elements in the current chunk, a number of elements in the first set of syntax elements, and a number of elements in the first set of syntax elements having a first particular value, the method further comprising:
coding, using at least a portion of a third set of syntax elements as context data, a fourth set of syntax elements of a chrominance component, wherein the third set of syntax elements comprises a second, different combination of one or more of the third set of syntax elements of the common block, the third set of syntax elements of neighboring coefficients within a current chunk, the third set of syntax elements of neighboring coefficients outside of the current chunk, the third set of syntax elements in a neighboring chunk, the third set of syntax elements in the current chunk, a number of elements in the third set of syntax elements, and a number of elements in the third set of syntax elements having a second particular value.

13. The method of claim 1, wherein the first set of syntax elements comprise values representative of whether respective ones of a first portion of the coefficients have level values that exceed one, and wherein the second set of syntax elements comprise values representative of whether respective ones of a second portion of the coefficients have level values that exceed one, wherein the second portion of the coefficients correspond to a current chunk of the residual block, and wherein the second portion of the coefficients correspond to one or more previous chunks of the residual block.

14. The method of claim 13, wherein coding the second set of syntax elements comprises determining a context for coding a current syntax element of the second set of syntax elements, wherein determining the context comprises:
calculating a numOnes value as a sum of a number of the first portion of the coefficients having level values that exceed one;
determining a C value corresponding to a context number in a context set;
determining an N value as a number of significant flags before the coefficient to which the current syntax element corresponds in the current chunk in scan order; and
calculating a context index for the context using a function of the numOnes value, the C value, and the N value.

15. The method of claim 14, wherein the function comprises one of:
context index=min(C,numOnes+(N>>1),
context index=min(C,(numOnes>0)+(N>>1)),
context index=min(C,(numOnes>>1)+(N>>1)), and
context index=min(C,(numOnes+N+1)>>1), wherein “>>” represents a bitwise right-shift operator.

16. The method of claim 1, wherein coding the first set of syntax elements comprises decoding the first set of syntax elements, wherein coding the second set of syntax elements comprises decoding the second set of syntax elements, the method further comprising reproducing the coefficients using the decoded first set of syntax elements and the decoded second set of syntax elements.

17. The method of claim 1, further comprising:
calculating pixel-by-pixel differences between an original block of video data and a predicted block of video data to produce the residual block; and
transforming and quantizing the residual block to produce the coefficients,
wherein coding the first set of syntax elements comprises encoding the first set of syntax elements, and
wherein coding the second set of syntax elements comprises encoding the second set of syntax elements.

18. A device for coding video data, the device comprising a video coder configured to code a first set of syntax elements for coefficients corresponding to a residual block of video data, and code, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

19. The device of claim 18, wherein the first set of syntax elements comprise significant coefficient flags of the coefficients.

20. The device of claim 19, wherein the second set of syntax elements comprise values representative of whether level values for the respective coefficients have absolute values that exceed one.

21. The device of claim 19, wherein the second set of syntax elements comprise values representative of whether level values for the respective coefficients have absolute values that exceed two.

22. The device of claim 21, wherein the video coder is configured to code the second set of syntax elements additionally using values representative of whether the level values for the coefficients have absolute values that exceed one as context data.

23. The device of claim 18, wherein the first set of syntax elements comprise values representative of whether level values for the coefficients have absolute values that exceed one, and wherein the second set of syntax elements comprise values representative of whether the level values for the respective coefficients have absolute values that exceed two.

24. The device of claim 18, wherein to use at least a portion of the first set of syntax elements as context data, the video coder is configured to use one or more of the first set of syntax elements of a common block, the first set of syntax elements of neighboring coefficients within a current chunk, the first set of syntax elements of neighboring coefficients outside of the current chunk, the first set of syntax elements in a neighboring chunk, the first set of syntax elements in the current chunk, a number of elements in the first set of syntax elements, and a number of elements in the first set of syntax elements having a particular value as context data.

25. The device of claim 24, wherein the first set of syntax elements comprise significant coefficient flags of the coefficients and wherein to use the at least portion of the first set of syntax elements as context data, the video coder is configured to use a first value representing a number of the significant coefficient flags having a value of one and a second value representing a number of the significant coefficient flags having a value of zero as context data.

26. The device of claim 18, wherein the video coder comprises a video decoder, wherein to code the first set of syntax elements, the video decoder is configured to decode the first set of syntax elements, wherein to code the second set of syntax elements, the video decoder is configured to decode the second set of syntax elements, and wherein the video decoder is further configured to reproduce the coefficients using the decoded first set of syntax elements and the decoded second set of syntax elements.

27. The device of claim 18, wherein the video coder comprises a video encoder, and wherein the video encoder is further configured to calculate pixel-by-pixel differences between an original block of video data and a predicted block of video data to produce the residual block, and to transform and quantize the residual block to produce the coefficients, wherein coding the first set of syntax elements comprises encoding the first set of syntax elements, and wherein coding the second set of syntax elements comprises encoding the second set of syntax elements.

28. The device of claims 18, wherein the device comprises at least one of:
an integrated circuit;
a microprocessor; and
a wireless communication device that includes the video coder.

29. A device for coding video data, the device comprising:
means for coding a first set of syntax elements for coefficients corresponding to a residual block of video data; and
means for coding, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

30. The device of claim 29, wherein the first set of syntax elements comprise significant coefficient flags of the coefficients.

31. The device of claim 30, wherein the second set of syntax elements comprise values representative of whether level values for the respective coefficients have absolute values that exceed one.

32. The device of claim 30, wherein the second set of syntax elements comprise values representative of whether level values for the respective coefficients have absolute values that exceed two.

33. The device of claim 32, wherein the means for coding the second set of syntax elements comprise means for coding the second set of syntax elements additionally using values representative of whether the level values for the coefficients have absolute values that exceed one as context data.

34. The device of claim 29, wherein the first set of syntax elements comprise values representative of whether level values for the coefficients have absolute values that exceed one, and wherein the second set of syntax elements comprise values representative of whether the level values for the respective coefficients have absolute values that exceed two.

35. The device of claim 29, wherein the means for using at least a portion of the first set of syntax elements as context data comprise means for using one or more of the first set of syntax elements of a common block, the first set of syntax elements of neighboring coefficients within a current chunk, the first set of syntax elements of neighboring coefficients outside of the current chunk, the first set of syntax elements in a neighboring chunk, the first set of syntax elements in the current chunk, a number of elements in the first set of syntax elements, and a number of elements in the first set of syntax elements having a particular value.

36. The device of claim 35, wherein the first set of syntax elements comprise significant coefficient flags of the coefficients, and wherein the means for using the at least portion of the first set of syntax elements as context data comprises means for using a first value representing a number of the significant coefficient flags having a value of one and a second value representing a number of the significant coefficient flags having a value of zero.

37. The device of claim 29, wherein the means for coding the first set of syntax elements comprise means for decoding the first set of syntax elements, wherein the means for coding the second set of syntax elements comprise means for decoding the second set of syntax elements, further comprising means for reproducing the coefficients using the decoded first set of syntax elements and the decoded second set of syntax elements.

38. The device of claim 29, further comprising:
means for calculating pixel-by-pixel differences between an original block of video data and a predicted block of video data to produce the residual block; and
means for transforming and quantizing the residual block to produce the coefficients,
wherein the means for coding the first set of syntax elements comprises means for encoding the first set of syntax elements, and
wherein the means for coding the second set of syntax elements comprises means for encoding the second set of syntax elements.

39. A computer-readable storage medium having stored thereon instructions that, when executed, cause a processor to:
code a first set of syntax elements for coefficients corresponding to a residual block of video data; and
code, using at least a portion of the first set of syntax elements as context data, a second set of syntax elements for the coefficients, wherein the first set of syntax elements each correspond to a first type of syntax element for the coefficients, and wherein the second set of syntax elements each correspond to a second, different type of syntax element for the coefficients.

40. The computer-readable storage medium of claim 39, wherein the first set of syntax elements comprise significant coefficient flags of the coefficients.

41. The computer-readable storage medium of claim 40, wherein the second set of syntax elements comprise values representative of whether level values for the respective coefficients have absolute values that exceed one.

42. The computer-readable storage medium of claim 40, wherein the second set of syntax elements comprise values representative of whether level values for the respective coefficients have absolute values that exceed two.

43. The computer-readable storage medium of claim 42, wherein the instructions that cause the processor to code the second set of syntax elements comprise instructions that cause the processor to code the second set of syntax elements additionally using values representative of whether the level values for the coefficients have absolute values that exceed one as context data.

44. The computer-readable storage medium of claim 39, wherein the first set of syntax elements comprise values representative of whether level values for the coefficients have absolute values that exceed one, and wherein the second set of syntax elements comprise values representative of whether the level values for the respective coefficients have absolute values that exceed two.

45. The computer-readable storage medium of claim 39, wherein the instructions that cause the processor to use at least a portion of the first set of syntax elements as context data comprise instructions that cause the processor to use one or more of the first set of syntax elements of a common block, the first set of syntax elements of neighboring coefficients within a current chunk, the first set of syntax elements of neighboring coefficients outside of the current chunk, the first set of syntax elements in a neighboring chunk, the first set of syntax elements in the current chunk, a number of elements in the first set of syntax elements, and a number of elements in the first set of syntax elements having a particular value.

46. The computer-readable storage medium of claim 45, wherein the first set of syntax elements comprise significant coefficient flags of the coefficients, and wherein the instructions that cause the processor to use the at least portion of the first set of syntax elements as context data comprise instructions that cause the processor to use a first value representing a number of the significant coefficient flags having a value of one and a second value representing a number of the significant coefficient flags having a value of zero.

47. The computer-readable storage medium of claim 39, wherein the instructions that cause the processor to code the first set of syntax elements comprise instructions that cause the processor to decode the first set of syntax elements, wherein the instructions that cause the processor to code the second set of syntax elements comprise instructions that cause the processor to decode the second set of syntax elements, further comprising instructions that cause the processor to reproduce the coefficients using the decoded first set of syntax elements and the decoded second set of syntax elements.

48. The computer-readable storage medium of claim 39, further comprising instructions that cause the processor to
calculate pixel-by-pixel differences between an original block of video data and a predicted block of video data to produce the residual block; and
transform and quantize the residual block to produce the coefficients,
wherein the instructions that cause the processor to code the first set of syntax elements comprise instructions that cause the processor to encode the first set of syntax elements, and
wherein the instructions that cause the processor to code the second set of syntax elements comprise instructions that cause the processor to encode the second set of syntax elements.
